(19) United States
(12) Patent Application Publication
(10) Pub. No.: US 2026/0070045 A1
(43) Pub. Date: Mar. 12, 2026

(54) CU ZEOLITE SELECTIVE CATALYTIC REDUCTION CATALYSTS AND METHODS FOR EXHAUST GAS TREATMENT

(71) Applicant: BASF MOBILE EMISSIONS CATALYSTS LLC, Iselin, NJ (US)

(72) Inventors: Wen-mei XUE, Iselin, NJ (US); Weiyong TANG, Iselin, NJ (US); Sandip D. SHAH, Iselin, NJ (US); Kevin A. HALLSTROM, Iselin, NJ (US)

(21) Appl. No.: 19/106,497

(22) PCT Filed: Aug. 22, 2023
(86) PCT No.: PCT/US2023/030767

§ 371 Date: Feb. 25, 2025

(30) Foreign Application Priority Data
Aug. 26, 2022 (EP) 22192453.3

(51) Int. Cl. B01J 29/76; B01D 53/94; B01J 29/78; B01J 35/57; B01J 37/02; B01J 37/08; B01J 37/30; F01N 3/20; F01N 3/28

(52) U.S. Cl. CPC B01J 29/763; B01D 53/9418; B01D 53/9477; B01J 29/783; B01J 35/57; B01J 37/0215; B01J 37/0236; B01J 37/08; B01J 37/30; F01N 3/2066; F01N 3/2803; B01D 2255/20715; B01D 2255/20723; B01D 2255/20761; B01D 2255/50; B01D 2255/9155; B01D 2257/404; B01D 2258/012; B01J 2229/183; F01N 2370/04; F01N 2510/063; F01N 2510/0684

(57) ABSTRACT

Disclosed herein are exhaust gas treatment systems comprising a combustion engine, and a selective catalytic reduction article downstream of the combustion engine; wherein the exhaust gas treatment system does not have a diesel oxidation catalyst in fluid communication between the combustion engine and the selective catalytic reduction article, the exhaust gas treatment system does not have a catalyzed soot filter in fluid communication between the combustion engine and the selective catalytic reduction article, and the selective catalytic reduction article has one or more washcoats comprising a copper containing small pore zeolite having a silica to alumina molar ratio ranging from 5 to less than 30. Also disclosed are methods for exhaust gas treatment comprising contacting the exhaust gas with a disclosed exhaust gas treatment system.

Disclosed herein are exhaust gas treatment systems comprising a combustion engine, and a selective catalytic reduction article downstream of the combustion engine; wherein the exhaust gas treatment system does not have a diesel oxidation catalyst in fluid communication between the combustion engine and the selective catalytic reduction article, the exhaust gas treatment system does not have a catalyzed soot filter in fluid communication between the combustion engine and the selective catalytic reduction article, and the selective catalytic reduction article has one or more washcoats comprising a copper containing small pore zeolite having a silica to alumina molar ratio ranging from 5 to less than 30. Also disclosed are methods for exhaust gas treatment comprising contacting the exhaust gas with a disclosed exhaust gas treatment system.

Internal combustion engines such as, for example, diesel engines have exhaust gas streams comprising pollutants such as, for example, particulate matter, nitrogen oxides, unburned hydrocarbons, and/or carbon monoxide.

Exhaust gas treatment systems and catalytic articles are exemplary means for pollution abatement from internal combustion engines. For example, some exhaust gas treatment systems comprise a diesel oxidation catalyst upstream of a selective catalytic reduction catalyst. Exemplary diesel oxidation catalysts are useful for abating pollutants such as, for example, unburned hydrocarbons and/or carbon monoxide. Exemplary selective catalytic reduction catalysts are useful for abating, e.g., nitrogen oxides (NOₓ). Effective abatement of pollutants may, however, be difficult to achieve in practice. For example, there may be tradeoffs between abatement of various pollutants, tradeoffs between abatement of a pollutant across different operating conditions of a combustion engine, and/or tradeoffs between performance of various catalytic articles within an exhaust gas treatment system.

Accordingly, there is a need for improved catalytic articles, exhaust gas treatment systems, and methods for treating an exhaust gas stream. For example, there is a need for catalytic articles, such as selective catalytic reduction articles, with enhanced pollution abatement. Further, there is a need for catalytic articles, such as selective catalytic reduction article, capable of enhancing the performance of downstream catalytic articles within an exhaust gas treatment system. For example, there is a need for a selective catalytic reduction article capable of selectively reducing NOₓ with low N₂O output.

I Disclosed herein are exhaust gas treatment systems comprising a combustion engine, and a selective catalytic reduction article downstream of the combustion engine; wherein the exhaust gas treatment system does not have a diesel oxidation catalyst in fluid communication between the combustion engine and the selective catalytic reduction article, the exhaust gas treatment system does not have a catalyzed soot filter in fluid communication between the combustion engine and the selective catalytic reduction article, and the selective catalytic reduction article has one or more washcoats comprising a copper containing small pore zeolite having a silica to alumina molar ratio ranging from 5 to less than 30.

In some embodiments, the exhaust gas treatment system does not have a catalytic article in fluid communication between the combustion engine and the selective catalytic reduction article.

In some embodiments, the copper containing small pore zeolite has an amount of copper ranging from 0.1 weight % CuO to 3 weight % CuO by total weight of the copper containing small pore zeolite.

In some embodiments, the one or more washcoats further comprise from 1 weight % to 10 weight % alumina by total weight of the one or more washcoats.

In some embodiments, the one or more washcoats comprise less than 1 weight % alumina by total weight of the one or more washcoats.

In some embodiments, the copper containing small pore zeolite has a molar ratio of copper to alumina ranging from 0.05 to 0.25.

In some embodiments, the one or more washcoats comprise less than 0.5 weight % vanadium by total weight of the one or more washcoats.

In some embodiments, the selective catalytic reduction article comprises a flow-through substrate.

In some embodiments, the exhaust gas treatment system further comprises a diesel oxidation catalyst downstream of the selective catalytic reduction article.

In some embodiments, the exhaust gas treatment system further comprises a catalyzed soot filter downstream of the selective catalytic reduction article.

In some embodiments, the selective catalytic reduction article comprises less than 1 weight % total of all metals other than copper, aluminum, magnesium, iron, and zirconium, by total weight of the selective catalytic reduction article.

In some embodiments, the selective catalytic reduction article comprises less than 1 weight % total of all elements other than copper, silicon, aluminum, oxygen, magnesium, iron, hydrogen, and zirconium, by total weight of the selective catalytic reduction article.

In some embodiments, the copper containing small pore zeolite comprises less than 1 weight % total of all metals other than copper, silicon, and aluminum, by total weight of the copper containing small pore zeolite.

Also disclosed methods for exhaust gas treatment comprising contacting the exhaust gas with a disclosed exhaust gas treatment system.

### BRIEF DESCRIPTION OF THE DRAWINGS

FIG. 1A depicts NOₓ conversion of exemplary embodiments.

FIG. 1B depicts N₂O selectivity of exemplary embodiments.

FIG. 2A depicts NOₓ conversion of exemplary embodiments.

FIG. 2B depicts N₂O selectivity of exemplary embodiments.

FIG. 2C depicts N₂O selectivity of exemplary embodiments.

FIG. 3A depicts NOₓ conversion of exemplary embodiments.

FIG. 3B depicts N₂O selectivity of exemplary embodiments.

FIG. 4 depicts hydrocarbon masking of exemplary embodiments.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, the term “about” refers to a range of ±5% of the stated number. For example, “about 100” means a number ranging from 95 to 105 including, e.g., 95, 100, and 105. Unless otherwise stated, all numbers are assumed to be modified by “about”.

As used herein, the term “platinum group metal,” abbreviated “PGM,” refers to ruthenium, rhodium, palladium, osmium, iridium, platinum, and combinations thereof.

As used herein, a “catalyzed soot filter” comprises a filter for trapping soot particles from an exhaust gas and a catalyst composition for oxidizing entrapped soot particles.

As used herein, the “loading” of a material such as, for example, a washcoat or a metal, on a substrate refers to the dry mass of the material coated on the substrate per unit volume of the substrate. For example, a washcoat loading of 1 g/in³ on a substrate means that the total dry mass of the washcoat per cubic inch of substrate is 1 gram. Further, for example, a platinum group metal loading of 1 g/ft³ on a substrate means that the total mass of platinum group metals per cubic foot of the substrate is 1 gram. The loading of a material may be local to a sub-volume of the substrate. Such loadings are reported as the total dray mass of the material coated on the sub-volume of the substrate per unit volume of the sub-volume of the substrate. For example, a substrate may have a first zone of X cubic inches in volume with a total dry washcoat mass of A g deposited thereon and a second zone of Y cubic inches in volume with a total dry washcoat mass of B g deposited thereon. In this example, the first zone has a washcoat loading of (A/X) g/in³ and the second zone has a washcoat loading of (B/Y) g/in³.

As used herein, the term “diesel oxidation catalyst” refers to a catalyst, comprising a platinum group metal, capable of oxidizing carbon monoxide, NO₂, and hydrocarbons when contacted with exhaust from a diesel engine.

As used herein, the term “NOₓ” refers to nitrogen oxides and mixtures thereof. Exemplary nitrogen oxides include, but are not limited to, NO, N₂O, NO₂, and N₂O₂.

As used herein, the term “selective catalytic reduction catalyst” refers to a catalyst capable of selectively reducing NOₓ to N₂ and water, optionally in the presence of a reductant such as NH₃.

As used herein, “particle size DX,” wherein X is a number ranging from 0 to 100, refers to the particle size at which about X % of the particles have a smaller particle size. For example, “particle size D90” refers to the particle size at which about 90% of the particles have a smaller particle size.

As used herein, the term “washcoat” refers to a coating applied to a substrate.

As used herein, a second entity is “downstream” of a first entity if the two entities are in fluid communication and fluid, such as an exhaust gas, flows from the first entity to the second entity; there may or may not be one or more additional entities in fluid communication between the first and second entity.

As used herein, a first entity is “upstream” of a second entity if the second entity is downstream of the first entity.

As used herein, zeolite framework types are as classified by the Structure Commission of the International Zeolite Association according to the rules of the IUPAC Commission on Zeolite Nomenclature. According to this classification, zeolite framework types are assigned a three letter code and are described in the Atlas of Zeolite Framework Types, 5th edition, Elsevier, London, England (2001).

As used herein, a “small pore zeolite” is a zeolite having 8 member-ring pore openings and a pore sizes less than 5 angstroms. Some exemplary small pore zeolites have a framework structure chosen from AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof.

As used herein, a zone on a substrate may or may not at least partially overlap another zone on the substrate.

As used herein, a layer on a substrate may or may not at least partially overlap another layer on the substrate.

### Exhaust Gas Treatment Systems:

Without wishing to be bound by theory, it is believed that hot exhaust gas coming from engine heats downstream catalytic components. As downstream components heat up, it is believed that they are exposed to different gas temperatures, different gas compositions, and the catalytic components heat up at different rates depending on their positioning downstream of the engine. Thus, it is believed that exhaust gas treatment may depend on both the positioning of catalytic components downstream from the engine as well as the composition of the catalytic components. For example, without wishing to be bound by theory, it is believed that a selective catalytic reduction article which is suitable for exhaust gas treatment when positioned downstream of, e.g., a diesel oxidation catalyst and/or catalyzed soot filter, may not be suitable for exhaust gas treatment when in a close-coupled position immediately downstream of the engine.

For example, the exhaust catalyst system may be heated by the hot exhaust gas coming from engine, therefore the upstream catalysts may be heated faster than the downstream catalysts. In some heavy duty diesel exhaust systems, the selective catalytic reduction (SCR) catalyst is placed downstream of DOC (diesel oxidation catalyst) and CSF (catalytic soot filter). In such systems, it may take some time for the SCR catalyst to reach its minimum operating temperature. During this heating up period, NOₓ emissions may take place and may result in a significant proportion of NOₓ emissions during the cold start. Without wishing to be bound by theory, it is believed that the SCR catalyst may be quickly heated up to its operating temperature when the SCR catalyst is positioned directly at the exhaust of the engine (i.e. the close-coupled position). At this position, it is believed that the SCR catalyst may be heated faster, and the conversion of NOₓ can start earlier.

However, it is believed that a close-coupled SCR (cc-SCR) catalyst may be exposed to a different environment from that of a downstream position. For example, hydrocarbons from engine exhaust will directly flow through the cc-SCR and may cause hydrocarbon poisoning. Similarly, SO₂, which may be present in engine exhausts, can lead to severe deactivation of SCR catalysts. In some exhaust gas treatment systems, SCR catalysts poisoned by sulfur may be regenerated at high temperatures, such as 550° C., which may be accomplished during the regeneration of the soot filter when the SCR catalyst is placed downstream of CSF. However, it may be challenging to achieve such a high temperature in a close-coupled position. Therefore, it may be beneficial for a cc-SCR to have a lower desulfation temperature such as 450° C. In addition, it may be beneficial for a SCR catalysts to have low selectivity towards undesirable greenhouse gases such as N₂O, to meet the stringent emission legislations such as Euro 7.

Some SCR catalysts may use, e.g., Cu-small pore or V₂O₅/TiO₂ in heavy duty diesel exhaust systems. While some V₂O₅ based SCR may have low N₂O selectivity and sulfur poisoning resistance, its NOₓ reduction activity may be reduced by hydrocarbon masking. Additionally, the volatility of V₂O₅ may limit its applications.

Disclosed herein are exhaust gas treatment systems comprising a combustion engine, and a selective catalytic reduction article downstream of the combustion engine; wherein the exhaust gas treatment system does not have a diesel oxidation catalyst in fluid communication between the combustion engine and the selective catalytic reduction article, the exhaust gas treatment system does not have a catalyzed soot filter in fluid communication between the combustion engine and the selective catalytic reduction article, and the selective catalytic reduction article has one or more washcoats comprising a copper containing small pore zeolite having a silica to alumina molar ratio ranging from 5 to less than 30.

In some embodiments, the exhaust gas treatment system does not have a catalytic article in fluid communication between the combustion engine and the selective catalytic reduction article.

In some embodiments, the exhaust gas treatment system further comprises a diesel oxidation catalyst downstream of the selective catalytic reduction article.

In some embodiments, the exhaust gas treatment system further comprises a catalyzed soot filter downstream of the selective catalytic reduction article.

### Catalytic Articles:

Disclosed are selective catalytic reduction articles comprising a copper containing small pore zeolite having a silica to alumina molar ratio ranging from 5 to less than 30.

In some embodiments, the copper containing small pore zeolite has a silica to alumina molar ratio ranging from 10 to 28. In some embodiments, the copper containing small pore zeolite has a silica to alumina molar ratio ranging from 10 to 25. In some embodiments, the copper containing small pore zeolite has a silica to alumina molar ratio ranging from 10 to 20. In some embodiments, the copper containing small pore zeolite has a silica to alumina molar ratio ranging from 15 to 20.

In some embodiments, the copper containing small pore zeolite has an amount of copper ranging from 0.1 weight % CuO to 3 weight % CuO by total weight of the copper containing small pore zeolite. The copper containing small pore zeolite has an amount of copper ranging from 0.1 weight % CuO to 3 weight % CuO by total weight of the copper containing small pore zeolite. In some embodiments, the copper containing small pore zeolite has an amount of copper ranging from 1.5 weight % CuO to 3 weight % CuO by total weight of the copper containing small pore zeolite.

In some embodiments, the copper containing small pore zeolite has a silica to alumina molar ratio ranging from 10 to 20 and has an amount of copper ranging from 1.5 weight % CuO to 3 weight % CuO by total weight of the copper containing small pore zeolite. In some embodiments, the copper containing small pore zeolite has a silica to alumina molar ratio ranging from 15 to 20 and has an amount of copper ranging from 1.75 weight % CuO to 2.5 weight % CuO by total weight of the copper containing small pore zeolite.

In some embodiments, the one or more washcoats further comprise from 1 weight % to 10 weight % alumina by total weight of the one or more washcoats.

In some embodiments, the one or more washcoats comprise less than 1 weight % alumina by total weight of the one or more washcoats.

In some embodiments, the copper containing small pore zeolite has a molar ratio of copper to alumina ranging from 0.05 to 0.25.

In some embodiments, the one or more washcoats comprise less than 0.5 weight % vanadium by total weight of the one or more washcoats

In some embodiments, the selective catalytic reduction article comprises a flow-through substrate.

In some embodiments, the selective catalytic reduction article comprises catalytic particles having a D90 particle size ranging from 3 μm to 11 μm, as measured with a Sympatec particle size analyzer.

In some embodiments, the selective catalytic reduction article comprises less than 1 weight % total of all metals other than copper, aluminum, magnesium, iron, and zirconium, by total weight of the selective catalytic reduction article. In some embodiments, the selective catalytic reduction article comprises less than 0.1 weight % total of all metals other than copper, aluminum, magnesium, iron, and zirconium, by total weight of the selective catalytic reduction article.

In some embodiments, the selective catalytic reduction article comprises less than 1 weight % total of all elements other than copper, silicon, aluminum, oxygen, magnesium, iron, hydrogen, and zirconium, by total weight of the selective catalytic reduction article. In some embodiments, the selective catalytic reduction article comprises less than 0.1 weight % total of all elements other than copper, silicon, aluminum, oxygen, magnesium, iron, hydrogen, and zirconium, by total weight of the selective catalytic reduction article.

In some embodiments, the copper containing small pore zeolite comprises less than 1 weight % total of all metals other than copper, silicon, and aluminum, by total weight of the copper containing small pore zeolite. In some embodiments, the copper containing small pore zeolite comprises less than 0.1 weight % total of all metals other than copper, silicon, and aluminum, by total weight of the copper containing small pore zeolite.

In some embodiments, a catalytic article comprises: a substrate having a length and comprising an inlet end, and an outlet end, one or more washcoats deposited thereon wherein at least one of the one or more washcoats comprises the copper containing small pore zeolite having a silica to alumina molar ratio ranging from 5 to less than 30.

In some embodiments, a washcoat has a loading ranging from 1 g/in³ to 5 g/in³. In some embodiments, a washcoat has a loading ranging from 0.5 g/in³ to 5 g/in³.

### Substrates:

In some embodiments, one or more washcoats are disposed on one or more substrates to form, e.g., a catalytic article. In some embodiments, the one or more substrates are 3-dimensional and have a length, a diameter, and a volume. In some embodiments, the one or more substrates are cylindrical. In some embodiments, the one or more substrates are not cylindrical. In some embodiments, the one or more substrates have an axial length from an inlet end to an outlet end.

In some embodiments, the one or more substrates are ceramic substrates. In some embodiments, the ceramic substrates are made of any suitable refractory material, e.g., cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

In some embodiments, the substrates comprise one or more metals or metal alloys. In some embodiments, a metallic substrate may include any metallic substrate, such as those with openings or “punch-outs” in the channel walls. In some embodiments, the metallic substrates may be employed in various shapes, such as pellets, compressed metallic fibers, corrugated sheets, or monolithic foams. In some embodiments, metallic substrates include heat-resistant, base-metal alloys, especially those in which iron is a substantial or major component. Such alloys may contain one or more of nickel, chromium, and aluminum, and the total of these metals may comprise at least about 15 wt % (weight percent) of the alloy, for instance, about 10 wt % to about 25 wt % chromium, about 1 wt % to about 8 wt % of aluminum, and about 0 wt % to about 20 wt % of nickel, in each case based on the weight of the substrate. In some embodiments, metallic substrates include those having straight channels; those having protruding blades along the axial channels to disrupt gas flow and to open communication of gas flow between channels; and those having blades and also holes to enhance gas transport between channels allowing for radial gas transport throughout the monolith.

In some embodiments, any suitable substrate may be employed, such as a monolithic substrate of the type having fine, parallel gas flow passages extending there through from an inlet to an outlet face of the substrate such that passages are open to fluid flow there through (“flow-through substrate”). In some embodiments, a substrate has a plurality of fine, substantially parallel gas flow passages extending along the longitudinal axis of the substrate where, e.g., each passage is blocked at one end of the substrate body, with alternate passages blocked at opposite end-faces (“wall-flow filter”).

In some embodiments, the substrate comprises a honeycomb substrate in the form of a wall-flow filter or a flow-through substrate. In some embodiments, the substrate is a wall-flow filter. In some embodiments, the substrate is a flow-through substrate.

In some embodiments, the substrate is a flow-through substrate (e.g., a monolithic substrate, including a flow-through honeycomb monolithic substrate). In some embodiments, flow-through substrates have fine, parallel gas flow passages extending from an inlet end to an outlet end of the substrate such that passages are open to fluid flow. In some embodiments, passages, which are paths from the inlet to the outlet, have walls on or in which a coating is disposed so that gases flowing through the passages contact the coated material. In some embodiments, the flow passages of the flow-through substrate are thin-walled channels, which can be of any suitable cross-sectional shape and size such as trapezoidal, rectangular, square, sinusoidal, hexagonal, oval, circular, etc. The flow-through substrate can be ceramic or metallic as described above.

Exemplary flow-through substrate volumes are not particularly limited. In some embodiments, flow-through substrates have a volume of from about 50 in³ to about 1200 in³, a cell density (inlet openings) of from about 60 cells per square inch (cpsi) to about 500 cpsi or up to about 900 cpsi, for example, from about 200 to about 400 cpsi, and a wall thickness of from about 50 microns to about 200 microns or about 400 microns.

In some embodiments, the substrate is a wall-flow filter having a plurality of fine passages extending along the longitudinal axis of the substrate. In some embodiments, each passage is blocked at one end of the substrate body, with alternate passages blocked at opposite end-faces. In some embodiments, monolithic wall-flow filter substrates may contain up to about 900 or more flow passages (or “cells”) per square inch of cross-section, although fewer may be used. For example, the substrate may have from about 7 to 600, e.g. from about 100 to 400, cells per square inch (“cpsi”). In some embodiments, the cells have cross-sections that are rectangular, square, circular, oval, triangular, hexagonal, or are of other polygonal shapes. In some embodiments, the wall-flow filter substrate is ceramic or metallic as described above.

Exemplary wall-flow filter article substrate volumes are not particularly limited. In some embodiments, the wall-flow filter article substrate has a volume of, for example, from about 50 cm³, about 100 in³, about 200 in³, about 300 in³, about 400 in³, about 500 in³, about 600 in³, about 700 in³, about 800 in³, about 900 in³ or about 1000 in³ to about 1500 in³, about 2000 in³, about 2500 in³, about 3000 in³, about 3500 in³, about 4000 in³, about 4500 in³ or about 5000 in³. In some embodiments, wall-flow filter substrates have a wall thickness from about 50 microns to about 500 microns, for example from about 50 microns to about 450 microns or from about 150 microns to about 400 microns.

In some embodiments, the walls of the wall-flow filter have a standard porosity or a high porosity. In some embodiments, the walls of the wall-flow filter have a wall porosity of at least about 40% or at least about 50% with an average pore diameter of at least about 10 microns prior to disposition of the functional coating. For example, in some embodiments, the wall-flow filter article substrate has a porosity of ≥40%, ≥50%, ≥60%, ≥65%, or ≥70%. In some embodiments, the wall-flow filter article substrate has a wall porosity of from about 50%, about 60%, about 65% or about 70% to about 75% and an average pore diameter of from about 10 microns, or about 20 microns, to about 30 microns, or about 40 microns prior to disposition of a catalytic coating. The terms “wall porosity” and “substrate porosity” mean the same thing and are used interchangeably herein. Porosity is the ratio of void volume (or pore volume) divided by the total volume of a substrate material. Pore size and pore size distribution may be determined by, e.g., Hg porosimetry measurement.

### Washcoats:

In some embodiments, a slurry is coated on a substrate using a washcoat technique known in the art. Washcoats are, for example, as described in Heck, Ronald and Farrauto, Robert, Catalytic Air Pollution Control, New York: Wiley-Interscience, 2002, pp. 18-19, as a compositionally distinct layer of material disposed on the surface of a monolithic substrate or an underlying washcoat layer. In some embodiments, a substrate contains one or more washcoat layers, and each washcoat layer can have different composition.

In some embodiments, the substrate is dipped one or more times in the slurry or otherwise coated with the slurry, e.g., sprayed. In some embodiments, the coated substrate is dried at an elevated temperature (e.g., 100° C. to 150° C.) in static air or under a flow or jet of air for about 2 minutes to about 3 hours, and then calcined by heating, e.g., at 400° C. to 600° C., for about 10 minutes to about 3 hours. In some embodiments, following drying and calcining, the final washcoat coating layer is essentially solvent-free.

In some embodiments, after calcining, the washcoat loading can be determined through calculation of the difference in coated and uncoated weights of the substrate. As will be apparent to those of skill in the art, the washcoat loading can be modified by altering the slurry rheology, solids content or number of coating operations. In some embodiments, the coating/drying/calcining process is repeated as needed to build the coating to the desired loading level or thickness.

In some embodiments, a composition is applied as a single layer or in multiple layers. In some embodiments, a layer resulting from repeated wash-coating of the same material to build up the loading level is a single layer. In some embodiments, a composition can be zone-coated, meaning a single substrate can be coated with different catalyst compositions in different areas along the axial gas effluent flow path.

In some embodiments, a composition is mixed with water to form a slurry for the purposes of coating a substrate. In some embodiments, the slurry further comprises an inorganic binder, an associative thickener, or a surfactant (e.g. one or more anionic, cationic, non-ionic or amphoteric surfactants). The order of addition can vary; in some embodiments, all components are simply combined together to form the slurry and, in some embodiments, certain components are combined and remaining components are then combined therewith. In some embodiments, the pH of the slurry can be adjusted, e.g., to an acidic pH of about 3 to about 5.

In some embodiments, the slurry is milled. In some embodiments, the milling is accomplished in a ball mill, continuous mill, or other similar equipment, and the solids content of the slurry may be, e.g., about 20 wt. %, to about 60 wt. %, about 30 wt. %, to about 40 wt. %. In some embodiments, the post-milling slurry is characterized by a D90 particle size of about 10 microns to about 50 microns (e.g., about 10 microns to about 20 microns).

In some embodiments, the first and second washcoats are in a layered relationship. In some embodiments, the first and second washcoats are in a layered relationship and the first washcoat is layered on top of the second washcoat which is directly layered on the substrate. In some embodiments, the first and second washcoats are in a layered relationship and the second washcoat is layered on top of the first washcoat which is directly layered on the substrate.

In some embodiments, the first and second washcoats are in a zoned relationship. In some embodiments, the first washcoat is in an upstream zone and the second washcoat is in a downstream zone. In some embodiments, the first washcoat is coated on x % of the axial length of the substrate; wherein x ranges from greater than 0% to less than 100% from the inlet face of the coated structure. In some embodiments, the second washcoat is coated on y % of the axial length of the substrate; wherein y ranges from greater than 0% to less than 100% from the outlet face of the coated structure. In some embodiments, x % is 10% and y % is 90%. In some embodiments, x % is 20% and y % is 80%. In some embodiments, x % is 30% and y % is 70%. In some embodiments, x % is 40% and y % is 60%. In some embodiments, x % is 50% and y % is 50%. In some embodiments, x % is 60% and y % is 40%. In some embodiments, x % is 70% and y % is 30%. In some embodiments, x % is 80% and y % is 20%. In some embodiments, x % is 90% and y % is 10%.

In some embodiments, the first and second washcoats are in a zoned and layered relationship wherein a portion of the first washcoat and a portion of the second washcoat overlap. In some embodiments, the first washcoat is coated, directly or indirectly, on x % of the axial length of the substrate; wherein x ranges from greater than 0% to less than 100% from the inlet face of the coated structure. In some embodiments, the second washcoat is coated, directly or indirectly, on y % of the axial length of the substrate; wherein y ranges from greater than 0% to less than 100% from the outlet face of the coated structure. In some embodiments, x %+y % ranges from 100% to 180%. In some embodiments, x %+y % ranges from 100% to 150%. In some embodiments, x %+y % ranges from 100% to 120%. In some embodiments, x %+y % ranges from 100% to 110%. In some embodiments, x %+y % ranges from 100% to 105%. In some embodiments, a portion of the first washcoat and a portion of the second washcoat overlap such that x %+y % is greater than 100%. In some embodiments, the first washcoat overlaps the second washcoat. In some embodiments, the second washcoat overlaps the first washcoat.

In some embodiments, the second washcoat is layered at least partially on top of the first washcoat, and the second washcoat comprises Pt, Mn, Zr, and optionally Pd.

### Catalyzed Soot Filters:

Catalyzed soot filters provide an exemplary means for trapping and oxidizing soot particles entrained within an engine exhaust stream. Non-limiting exemplary catalyzed soot filters comprise a catalyst composition comprising platinum group metal, wherein the catalyst composition is deposed on a wall-flow substrate filter. Non-limiting exemplary catalyzed soot filters are disclosed in International Application No. PCT/US2004/024864, filed Jul. 30, 2004; International Application No. PCT/US2006/043574, filed Nov. 8, 2006; International Application No. PCT/US2007/086095, filed Nov. 30, 2007; International Application No. PCT/US2016/024889, filed Mar. 30, 2016; and International Application No. PCT/US2011/061681, filed Nov. 21, 2011; the disclosure of each of which is incorporated herein by reference in its entirety.

### Diesel Oxidation Catalyst

Diesel oxidation catalysts provide an exemplary means for oxidizing carbon monoxide and hydrocarbons when contacted with exhaust from a diesel engine. Non-limiting exemplary diesel oxidation catalysts are disclosed in International Application No. PCT/US2010/021105, filed Jan. 15, 2010; International Application No. PCT/US2010/030226, filed Apr. 7, 2010; International Application No. PCT/EP2013/073495, filed Nov. 11, 2013; International Application No. PCT/US2012/067208, filed Nov. 30, 2012; U.S. Pat. No. 7,875,573; International Application No. PCT/US2021/071898, filed Oct. 15, 2021; International Application No. PCT/IB2019/054454, filed May 29, 2019; International Application No. PCT/IB2017/053514, filed Jun. 13, 2017; and International Application No. PCT/US2014/070356, filed Dec. 15, 2014; the disclosure of each of which is incorporated herein by reference in its entirety.

### Methods of Treating an Exhaust Gas:

Disclosed are methods for exhaust gas treatment comprising contacting the exhaust gas with an exhaust gas treatment system disclosed herein.

### Non-Limiting Exemplary Embodiments:

Without limitation, some embodiments of this disclosure include:
1. An exhaust gas treatment system comprising: a combustion engine, and a selective catalytic reduction article downstream of the combustion engine; wherein: the exhaust gas treatment system does not have a diesel oxidation catalyst in fluid communication between the combustion engine and the selective catalytic reduction article, the exhaust gas treatment system does not have a catalyzed soot filter in fluid communication between the combustion engine and the selective catalytic reduction article, the selective catalytic reduction article has one or more washcoats comprising a copper containing small pore zeolite having a silica to alumina molar ratio ranging from 5 to less than 30, the copper containing small pore zeolite has an amount of copper ranging from 0.1 weight % CuO to 3 weight % CuO by total weight of the copper containing small pore zeolite, and the copper containing small pore zeolite has a molar ratio of copper to alumina ranging from 0.05 to 0.25.
2. The exhaust gas treatment system according to embodiment 1, wherein the exhaust gas treatment system does not have a catalytic article in fluid communication between the combustion engine and the selective catalytic reduction article.
3. The exhaust gas treatment system according to embodiment 1 or 2, wherein the copper containing small pore zeolite has a framework structure chosen from AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof.
4. The exhaust gas treatment system according to any one of embodiments 1 to 3, wherein the one or more washcoats further comprise from 1 weight % to 10 weight % alumina by total weight of the one or more washcoats.
5. The exhaust gas treatment system according to any one of embodiments 1 to 3, wherein the one or more washcoats comprise less than 1 weight % alumina by total weight of the one or more washcoats.
6. The exhaust gas treatment system according to any one of embodiments 1 to 5, wherein the copper containing small pore zeolite has a chabazite framework structure.
7. The exhaust gas treatment system according to any one of embodiments 1 to 6, wherein the one or more washcoats comprise less than 0.5 weight % vanadium by total weight of the one or more washcoats.
8. The exhaust gas treatment system according to any one of embodiments 1 to 7, wherein the selective catalytic reduction article comprises a flow-through substrate.
9. The exhaust gas treatment system according to any one of embodiments 1 to 8, further comprising a diesel oxidation catalyst downstream of the selective catalytic reduction article.
10. The exhaust gas treatment system according to any one of embodiments 1 to 9, further comprising a catalyzed soot filter downstream of the selective catalytic reduction article.
11. The exhaust gas treatment system according to any one of embodiments 1 to 10, wherein the selective catalytic reduction article comprises less than 1 weight % total of all metals other than copper, aluminum, magnesium, iron, and zirconium, by total weight of the selective catalytic reduction article.
12. The exhaust gas treatment system according to any one of embodiments 1 to 11, wherein the selective catalytic reduction article comprises less than 1 weight % total of all elements other than copper, silicon, aluminum, oxygen, magnesium, iron, hydrogen, and zirconium, by total weight of the selective catalytic reduction article.
13. The exhaust gas treatment system according to any one of embodiments 1 to 11, wherein the copper containing small pore zeolite comprises less than 1 weight % total of all metals other than copper, silicon, and aluminum, by total weight of the copper containing small pore zeolite.
14. A method for exhaust gas treatment comprising: contacting the exhaust gas with an exhaust gas treatment system according to any one of embodiments 1 to 10.

### EXAMPLES

The following examples are intended to be illustrative and are not meant in any way to limit the scope of the disclosure.

### Example 1 Preparation of a Catalytic Article Comprising Cu/SSZ-13 (SAR=17, CuO %=1.75%)

93.3 parts by weight of the hydrogen-form of SSZ-13, 1.7 parts by weight of CuO and 5.0 parts by weight of zirconium acetate calculated as ZrO₂ were mixed into deionized water to form a slurry. The slurry was milled to a particle size of D₉₀ between 6 μm to 9 μm, as measured with a Sympatec particle size analyzer. The slurry was mixed for 20 hours at room temperature to allow copper ions to exchange into the zeolite framework. The final slurry was coated onto a flow-through cordierite monolith substrate having a cell density of 400 cpsi and a wall thickness of 4 mil, followed by drying at 130° C. and calcination at 550° C. The washcoat loading was 2.75 g/in³.

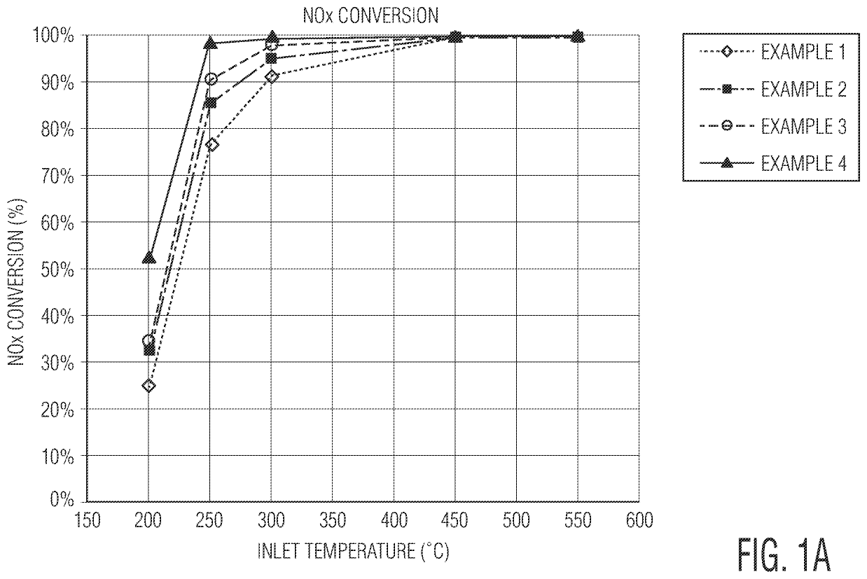

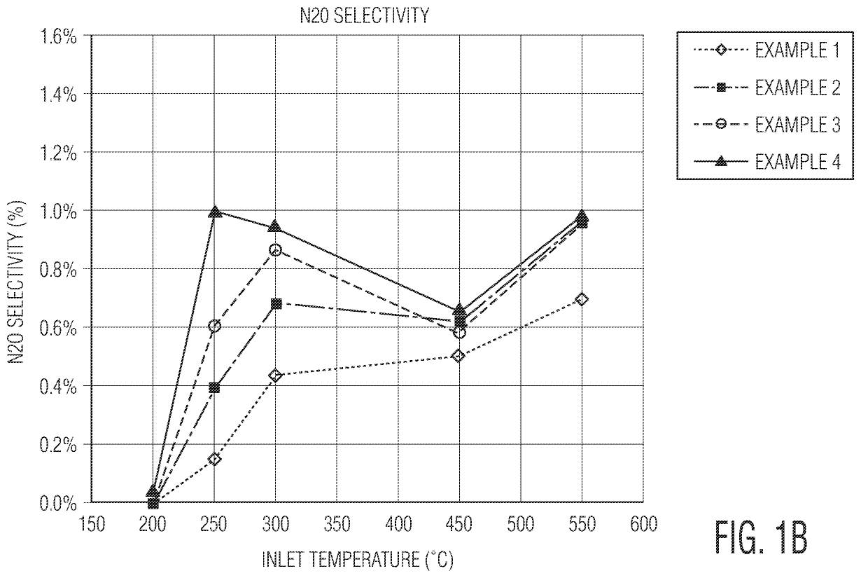

FIG. 1A depicts NOₓ conversion and FIG. 1B depicts N₂O selectivity for Example 1 after hydrothermal aging as described below.

### Example 2 Preparation of a Catalytic Article Comprising Cu/SSZ-13 (SAR=17, CuO %=2.0%)

93.1 parts by weight of the hydrogen-form of SSZ-13, 1.9 parts by weight of CuO and 5.0 parts by weight of zirconium acetate calculated as ZrO₂ were mixed into deionized water to form a slurry. The slurry was milled to a particle size of D₉₀ between 6 μm to 9 μm, as measured with a Sympatec particle size analyzer. The slurry was mixed for 20 hours at room temperature to allow copper ions to exchange into the zeolite framework. The final slurry was coated onto a flow-through cordierite monolith substrate having a cell density of 400 cpsi and a wall thickness of 4 mil, followed by drying at 130° C. and calcination at 550° C. The washcoat loading was 2.75 g/in³.

FIG. 1A depicts NOₓ conversion and FIG. 1B depicts N₂O selectivity for Example 2 after hydrothermal aging as described below.

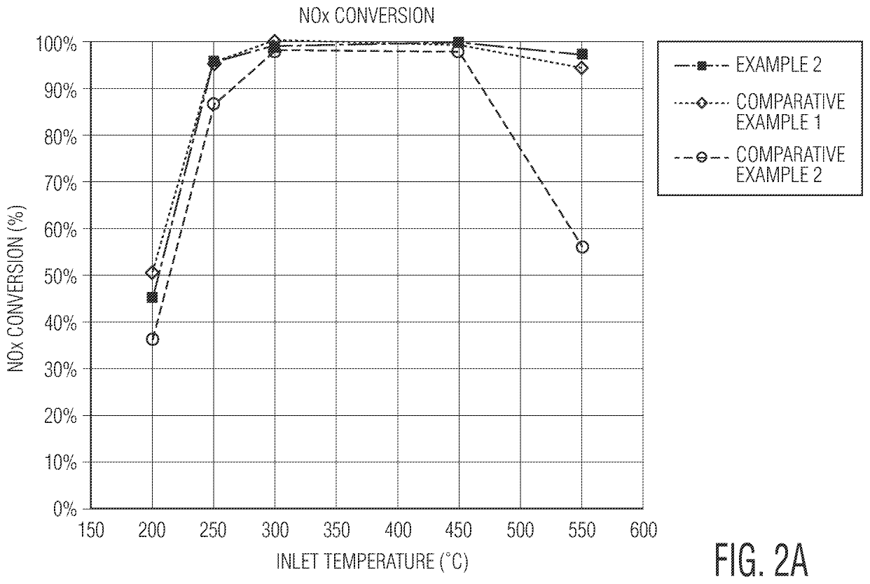

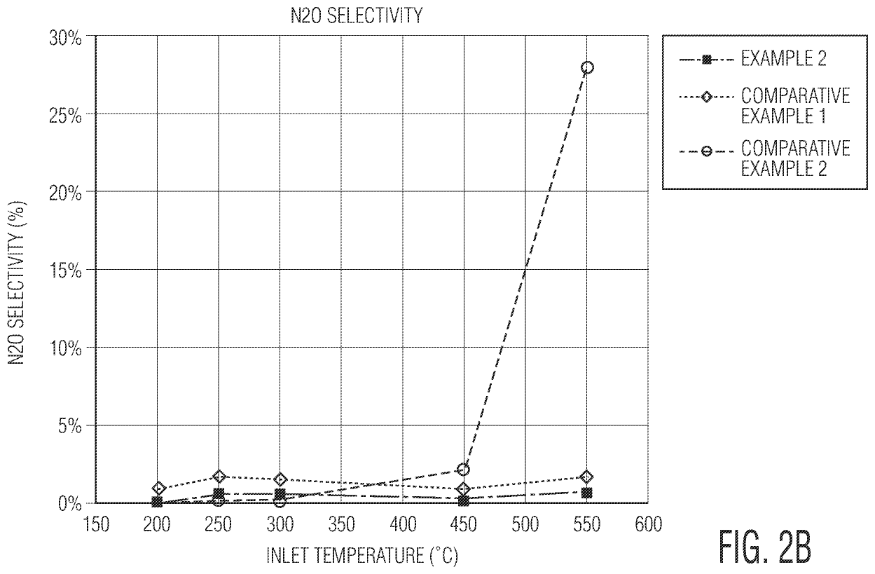

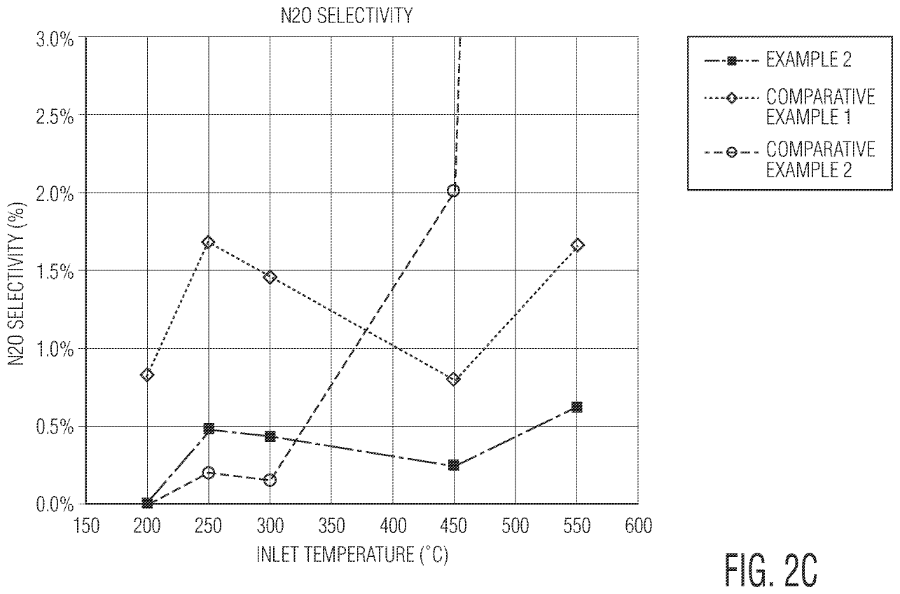

FIGS. 2A and B compare NOₓ conversion and N₂O selectivity to comparative examples 1 and 2 as described below.

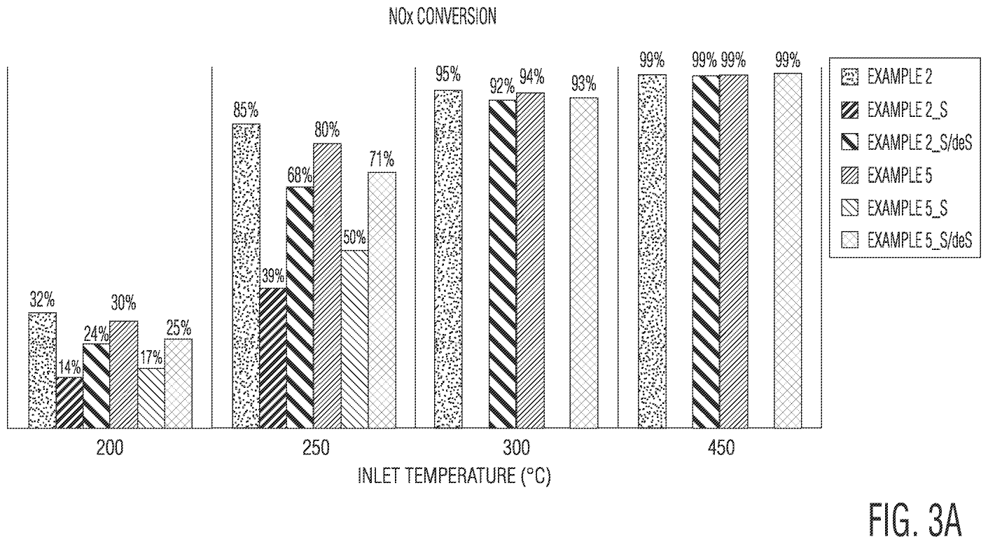

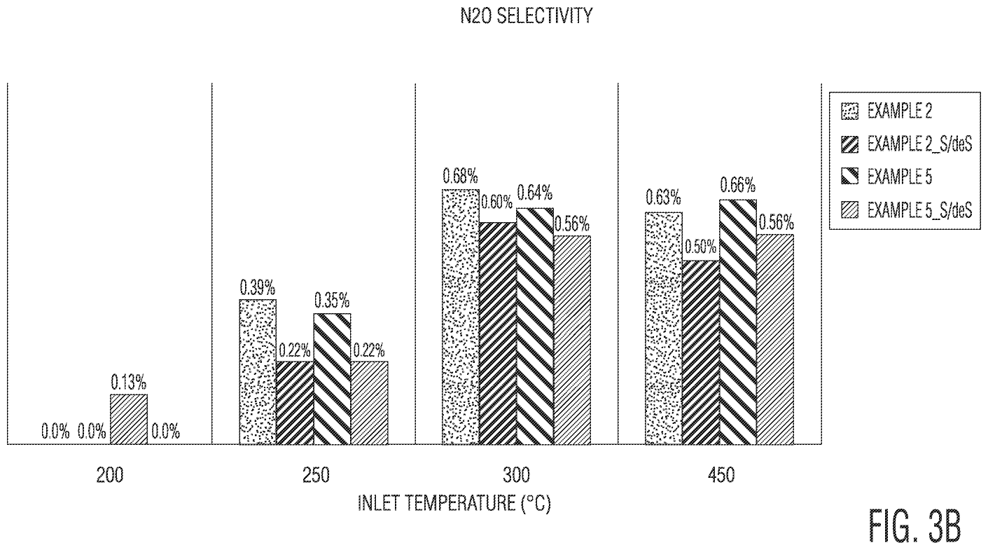

FIG. 3 shows NOₓ conversion (3A) and N₂O selectivity (3B) of Example 2 after hydrothermal aging and prior to sulfation, post sulfation, and post desulfation as described below.

### Example 3 Preparation of a Catalytic Article Comprising Cu/SSZ-13 (SAR=17, CuO %=2.25%)

92.9 parts by weight of the hydrogen-form of SSZ-13, 2.1 parts by weight of CuO and 5.0 parts by weight of zirconium acetate calculated as ZrO₂ were mixed into deionized water to form a slurry. The slurry was milled to a particle size of D₉₀ between 6 μm to 9 μm, as measured with a Sympatec particle size analyzer. The slurry was mixed for 20 hours at room temperature to allow copper ions to exchange into the zeolite framework. The final slurry was coated onto a flow-through cordierite monolith substrate having a cell density of 400 cpsi and a wall thickness of 4 mil, followed by drying at 130° C. and calcination at 550° C. The washcoat loading was 2.75 g/in³.

FIG. 1A depicts NOₓ conversion and FIG. 1B depicts N₂O selectivity for Example 3 after hydrothermal aging as described below.

### Example 4 Preparation of a Catalytic Article Comprising Cu/SSZ-13 (SAR=17, CuO %=2.5%)

92.6 parts by weight of the hydrogen-form of SSZ-13, 2.4 parts by weight of CuO and 5.0 parts by weight of zirconium acetate calculated as ZrO₂ were mixed into deionized water to form a slurry. The slurry was milled to a particle size of D₉₀ between 6 μm to 9 μm, as measured with a Sympatec particle size analyzer. The slurry was mixed for 20 hours at room temperature to allow copper ions to exchange into the zeolite framework. The final slurry was coated onto a flow-through cordierite monolith substrate having a cell density of 400 cpsi and a wall thickness of 4 mil, followed by drying at 130° C. and calcination at 550° C. The washcoat loading was 2.75 g/in³.

FIG. 1A depicts NOₓ conversion and FIG. 1B depicts N₂O selectivity for Example 4 after hydrothermal aging as described below.

### Example 5 Preparation of a Catalytic Article Comprising Cu/SSZ-13 (SAR=17, CuO %=2.0%)

88.7 parts by weight of the hydrogen-form of SSZ-13, 1.8 parts by weight of CuO, 4.8 parts by weight of dispersible Boehmite alumina, 4.8 parts by weight of zirconium acetate calculated as ZrO₂ were mixed into deionized water to form a slurry. The slurry was milled to a particle size of D₉₀ between 6 to 9 μm, as measured with a Sympatec particle size analyzer. The slurry was mixed for 20 hours at room temperature to allow copper ions to exchange into the zeolite framework. The final slurry was coated onto a flow-through cordierite monolith substrate having a cell density of 400 cpsi and a wall thickness of 4 mil, followed by drying at 130° C. and calcination at 550° C. The washcoat loading was 2.9 g/in³.

FIG. 3 shows NOₓ conversion (3A) and N₂O selectivity (3B) of Example 5 after hydrothermal aging and prior to sulfation, post sulfation, and post desulfation, as described below.

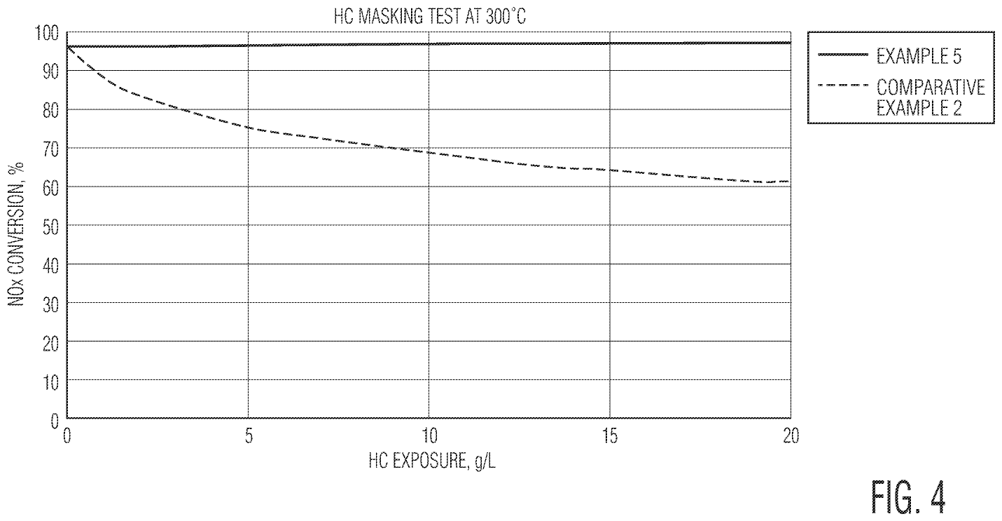

FIG. 4 compares hydrocarbon masking effects for Example 5 and comparative Example 2, as discussed below.

### Comparative Example 1 Preparation of a Catalytic Article Comprising Cu/SSZ-13 (SAR=30, CuO %=2.4 wt %)

95 parts by weight of Cu/SSZ-13 containing 2.4% CuO and 5 parts by weight of zirconium acetate calculated as ZrO₂ were mixed in a weight ratio of 95:5 into deionized water to form a slurry. The slurry was then milled to a particle size of D₉₀ between 7 to 10 μm, as measured with a Sympatec particle size analyzer. The milled slurry was coated onto a flow-through cordierite monolith substrate having a cell density of 600 cpsi and a wall thickness of 3 mil, followed by drying at 130° C. and calcination at 450° C. The washcoat loading was 2.5 g/in³.

### Comparative Example 2 Preparation of a Catalytic Article Comprising V₂O₅

An amount of TiO₂ that has been pre-doped with SbO₃ (6%) and V₂O₅ (4%) was combined with DI-H₂O and a polymer based dispersant such that solids content after mixing was 53%; the quantity of polymeric dispersant is 3% of the final targeted washcoat loading of the catalyst. pH is set to 7-7.5 using ammonium hydroxide solution. Then a colloidal based silica binder was added such that 5% of the final washcoat loading was made of the silica binder. Particle size D90 was in the range of 1 μm to 8 μm with high shear mixing or milling. The slurry is coated onto a flow-through cordierite monolith substrate having a cell density of 300 cpsi, followed by drying at 110-120° C. and calcination at 450° C. The washcoat loading is 4.0 g/in³.

### Sulfurization and Desulfurization

Sulfurization: A gas stream containing 35 ppmv SO₂, 10 vol % O₂, 8 vol % CO₂, 7 vol % H₂O and balanced N₂ at 60,000 hr⁻¹ space velocity based on the volume of the SCR catalyst was passed through the SCR catalyst. The inlet temperature of the SCR catalyst was maintained at 300° C. The gas stream was continued for a period of time to produce 10 g/L of S exposure based on the volume of SCR, to provide a sulfurized SCR catalyst.

Desulfurization: A gas stream containing 1000 ppmv NO, 1050 ppmv NH₃, 10 vol % O₂, 7 vol % H₂O, 8 vol % CO₂ and balanced N₂ was passed through the sulfurized SCR catalyst at a space velocity of 60,000 h⁻¹, 450° C. for 30 minutes, to provide a desulfurized SCR catalyst.

### Test of NOx Conversion and N2O Selectivity

The NOx conversion was tested using a flow reactor under pseudo-steady state conditions with a gas stream of 1000 ppmv NO, 1050 ppmv NH₃, 10 vol % O₂, 7 vol % H₂O, 8 vol % CO₂ and balanced N₂, at a space velocity of 60,000 h⁻¹. NOx conversion is reported as mol % and measured as NO and NO₂. NOx conversion was calculated in accordance with the following equation:

$$NOx Conversion ( \% ) = \frac{\begin{matrix}( Inlet NOx Concentration - \\ Outlet NOx Concentration ) \times 100 \%\end{matrix}}{Inlet NOx Concentration}$$

N₂O selectivity was calculated in accordance with the following equation:

$$N 2 O Selectivity ( \% ) = \frac{\begin{matrix}( Outlet N 2 O Concentration - \\ Inlet N 2 O Concentration ) \times 2 \times 100 \%\end{matrix}}{\begin{matrix}( Inlet NOx Concentration - \\ Outlet NOx Concentration )\end{matrix}}$$

### Test Protocol for HC Masking

For this test, a 1″ diameter and 3″ long core was mounted into a reactor. Feed gases were adjusted such that the space velocity based on the core volume was 60 k/h. The feed gas stream has a constant concentration of NH3=550 ppm, NO=500 ppm, O₂=10%, H₂O=5%, and N₂ as the balancing component. The temperature of the inlet of the catalyst was adjusted to 300° C. and it was held at this condition for most of the test. The catalyst was allowed to equilibrate for 20 minutes. At this point, 1000 ppmC1 diesel was added into the gas stream. The diesel was dosed via a mass flow controller as a liquid into a pre-heated (230° C.) high pressure gas stream. Upon impaction to the gas stream, the liquid diesel was atomized and flown into two evaporation chambers, oriented in serial to each other. The evaporation chambers are insulated to remain approximately close to 230° C. Upon exiting the second evaporation chamber, the diesel fuel should be fully evaporated and was routed to join with the primary gas feed stream. Using this described procedure, 1000 ppmC1 diesel was injected for 1 hour to the catalyst while maintaining all other conditions and gas compositions. An FTIR downstream of the catalyst monitors NOx concentrations.

FIG. 1A shows NOₓ conversion and FIG. 1B N₂O selectivity of Examples 1, 2, 3, 4. The samples were tested after hydrothermal aging at 550° C. for 200 hours with a gas stream of 10 vol % H₂O, 10 vol % O₂ and balanced N₂, at a flow rate of 20 liter per minute.

With increased Cu/Al ratio from 0.127 (1.75% CuO), to 0.146 (2.0% CuO), to 0.164 (2.25% CuO), 0.183 (2.5% CuO), NOₓ conversion increased and N₂O selectivity also increased.

Comparative Example 1, although the CuO content is low (2.4%), its N₂O selectivity is surprisingly higher than the examples 1-5. Without wishing to be bound by theory, it is believed that this difference may be due to the Cu/Al ratio (0.29).

FIG. 2 shows NOₓ conversion and N₂O selectivity of Example 2 and Comparative Examples 1 and 2. The samples were tested after hydrothermal aging at 550° C. for 100 hours with a gas stream of 10 vol % H₂O, 10 vol % O₂ and balanced N₂, at a flow rate of 20 liter per minute. Example 2 shows similar NOₓ conversion to Comparative Example 1 but has surprisingly lower N₂O selectivity. In some embodiments, low N₂O selectivity is an important feature for the SCR catalyst being used in closed coupled position, in order to meet stringent N₂O regulation targets.

NOₓ conversion of Example 2 was similar to Comparative Example 2 in low temperature and surprisingly higher in high temperature. N₂O selectivity of Example 2 was surprisingly lower than Comparative Example 2 in high temperature. Example 5 contained 4.8% of dispersible Boehmite alumina whereas Example 2 did not. Without wishing to be bound by theory, it is believed that the addition of alumina improved catalyst tolerance against sulfur poisoning.

FIG. 3 shows NOₓ conversion and N₂O selectivity of Examples 2 and 5 prior to sulfation, post sulfation, and post desulfation. The samples were tested after hydrothermal aging at 550° C. for 200 hours with a gas stream of 10 vol % H₂O, 10 vol % O₂ and balanced N₂, at a flow rate of 20 liter per minute. Example 5 showed higher NOₓ conversion than Example 2 post sulfation and post desulfation. Examples 2 and 5 had similar N₂O selectivity.

Hydrocarbon tolerance of Example 5 and Comparative Example 2 are shown in FIG. 4. Examples 1-5 had similar NOx conversion in the presence of hydrocarbons as compared to in the absence of hydrocarbons.

Without wishing to be bound by theory, it is believed that the combination of a small pore zeolite having a silica to alumina ratio ranging from 5 to less than 30, an amount of copper ranging from 0.1 weight % CuO to 3 weight % CuO by total weight of the copper containing small pore zeolite, and a molar ratio of copper to alumina ranging from 0.05 to 0.25 provides reduced N₂O selectivity in the close coupling position. For example, it is believed that small pore zeolites having a low molar ratio of copper to alumina and a low silica to alumina ratio may have an improved partitioning of the bound copper to either sites having one framework aluminum atom or sites having two framework aluminum atoms. The catalytic activity of copper bound to one framework aluminum atom is believed to be different from that of copper bound to two framework aluminum atoms. Thus, it is believed that small pore zeolites having a low molar ratio of copper to alumina and a low silica to alumina ratio may reduce N₂O selectivity relative to small pore zeolites which do not have a low molar ratio of copper to alumina and a low silica to alumina ratio.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

What is claimed is:

1. An exhaust gas treatment system comprising:
a combustion engine, and
a selective catalytic reduction article downstream of the combustion engine;
wherein:
the exhaust gas treatment system does not have a diesel oxidation catalyst in fluid communication between the combustion engine and the selective catalytic reduction article,
the exhaust gas treatment system does not have a catalyzed soot filter in fluid communication between the combustion engine and the selective catalytic reduction article,
the selective catalytic reduction article has one or more washcoats comprising a copper containing small pore zeolite having a silica to alumina molar ratio ranging from 5 to less than 30,
the copper containing small pore zeolite has an amount of copper ranging from 0.1 weight % CuO to 3 weight % CuO by total weight of the copper containing small pore zeolite, and
the copper containing small pore zeolite has a molar ratio of copper to alumina ranging from 0.05 to 0.25.

2. The exhaust gas treatment system according to claim 1, wherein the exhaust gas treatment system does not have a catalytic article in fluid communication between the combustion engine and the selective catalytic reduction article.

3. The exhaust gas treatment system according to claim 1, wherein the copper containing small pore zeolite has a framework structure chosen from AEI, AFT, AFV, AFX, A VL, CHA, DDR, EAB, EEi, ERi, IFY, IRN, KFI, LEV, LTA, LTN, MER, MWF, NPT, PAU, RHO, RTE, RTH, SAS, SAT, SAV, SFW, TSC, UFI, and combinations thereof.

4. The exhaust gas treatment system according to claim 1, wherein the one or more washcoats further comprise from 1 weight % to 10 weight % alumina by total weight of the one or more washcoats.

5. The exhaust gas treatment system according to claim 1, wherein the one or more washcoats comprise less than 1 weight % alumina by total weight of the one or more washcoats.

6. The exhaust gas treatment system according to claim 1, wherein the copper containing small pore zeolite has a chabazite framework structure.

7. The exhaust gas treatment system according to claim 1, wherein the one or more washcoats comprise less than 0.5 weight % vanadium by total weight of the one or more washcoats.

8. The exhaust gas treatment system according to claim 1, wherein the selective catalytic reduction article comprises a flow-through substrate.

9. The exhaust gas treatment system according to claim 1, further comprising a diesel oxidation catalyst downstream of the selective catalytic reduction article.

10. The exhaust gas treatment system according to claim 1, further comprising a catalyzed soot filter downstream of the selective catalytic reduction article.

11. The exhaust gas treatment system according to claim 1, wherein the selective catalytic reduction article comprises less than 1 weight % total of all metals other than copper, aluminum, magnesium, iron, and zirconium, by total weight of the selective catalytic reduction article.

12. The exhaust gas treatment system according to claim 1, wherein the selective catalytic reduction article comprises less than 1 weight % total of all elements other than copper, silicon, aluminum, oxygen, magnesium, iron, hydrogen, and zirconium, by total weight of the selective catalytic reduction article.

13. The exhaust gas treatment system according to claim 1, wherein the copper containing small pore zeolite comprises less than 1 weight % total of all metals other than copper, silicon, and aluminum, by total weight of the copper containing small pore zeolite.

14. A method for exhaust gas treatment comprising: contacting the exhaust gas with an exhaust gas treatment system according to claim 1.
